(19) United States
(12) Patent Application Publication
(10) Pub. No.: US 2025/0266936 A1
(43) Pub. Date: Aug. 21, 2025

(54) DATA TRANSMISSION METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventor: Neng WANG, Shenzhen (CN)

(21) Appl. No.: 19/200,017

(22) Filed: May 6, 2025

Related U.S. Application Data
(63) Continuation of application No. PCT/CN2023/129989, filed on Nov. 6, 2023.

(30) Foreign Application Priority Data
Apr. 27, 2023 (CN) 202310481614.5

(51) Int. Cl. H04L 1/1829; H04L 67/10

(52) U.S. Cl. CPC H04L 1/1854; H04L 67/10

(57) ABSTRACT

A data transmission method includes: transmitting, by a leader node, a generated proposal to N follower nodes in a regional chain system, and recording a quantity of transmissions of the proposal from the leader node to each of the N follower nodes; receiving node state information transmitted by M follower nodes of the N follower nodes, and determining a first node of the N follower nodes not receiving the proposal based on the node state information of the M follower nodes; obtaining a quantity of transmissions of the proposal from the leader node to the first node, and determining a time interval before a next transmission of the proposal to the first node based on the quantity of transmissions of the proposal to the first node, the time interval being positively correlated with the quantity of transmissions; and retransmitting the proposal to the first node based on the time interval.

### CROSS-REFERENCES TO RELATED APPLICATIONS

This application is a continuation of PCT Application No. PCT/CN2023/129989, filed on Nov. 6, 2023, which claims priority to Chinese Patent Application No. 2023104816145, filed with the China National Intellectual Property Administration on Apr. 27, 2023, and entitled “DATA TRANSMISSION METHOD AND APPARATUS, DEVICE, AND STORAGE MEDIUM”, the entire contents of all of which are incorporated herein by reference.

### FIELD OF THE TECHNOLOGY

Embodiments of the present disclosure relate to the field of computer technologies, and in particular, to a data transmission method and apparatus, a device, and a storage medium.

### BACKGROUND OF THE DISCLOSURE

In a blockchain system, a core of a Byzantine consensus algorithm is that a leader node packages transactions into a proposal (or a block) and then broadcasts the proposal to other nodes for consensus processing. However, the transmission of the proposal to the other nodes in a regional chain by the leader node may fail due to an unstable network, packet losses, disconnection, and the like. In this case, the leader node needs to retransmit the proposal to nodes not receiving the proposal, to ensure that the consensus processing of a regional chain system runs stably and continuously.

Currently, to ensure consensus performance of the regional chain system, the leader node usually retransmits the proposal to the nodes in the regional chain not receiving the proposal every one second. However, for some proposals with a relatively large amount of data, the current proposal retransmission method may cause network congestion, which affects overall performance of the regional chain system.

### SUMMARY

The present disclosure provides a data transmission method and apparatus, a device, and a storage medium, which can improve data retransmission efficiency in a blockchain system, thereby improving performance of the blockchain system.

According to a first aspect, the present disclosure provides a data transmission method, the method being applied to a leader node in a blockchain system, and including: transmitting a generated proposal to N follower nodes in a regional chain system, and recording a quantity of transmissions of the proposal from the leader node to each of the N follower nodes, N being a positive integer; receiving node state information transmitted by M follower nodes of the N follower nodes, and determining a first node of the N follower nodes not receiving the proposal based on the node state information of each of the M follower nodes, M being a positive integer less than or equal to N; obtaining a currently recorded quantity of transmissions of the proposal from the leader node to the first node, and determining a time interval before a next transmission of the proposal from the leader node to the first node based on the quantity of transmissions of the proposal from the leader node to the first node, the time interval being positively correlated with the quantity of transmissions of the proposal from the leader node to the first node, and the time interval being a time difference between a time of a next transmission of the proposal from the leader node to the follower node and a time of a last transmission of the proposal from the leader node to the follower node; and retransmitting the proposal to the first node based on the time interval.

According to a second aspect, the present disclosure provides a data transmission apparatus, the apparatus being applied to a leader node in a blockchain system, and including: a recording unit, configured to transmit a generated proposal to N follower nodes in a regional chain system, and record a quantity of transmissions of the proposal from the leader node to each of the N follower nodes, N being a positive integer; a first node determining unit, configured to receive node state information transmitted by M follower nodes of the N follower nodes, and determine a first node of the N follower nodes not receiving the proposal based on the node state information of each of the M follower nodes, M being a positive integer less than or equal to N; a time interval determining unit, configured to obtain a currently recorded quantity of transmissions of the proposal from the leader node to the first node, and determine a time interval before a next transmission of the proposal from the leader node to the first node based on the quantity of transmissions of the proposal from the leader node to the first node, the time interval being positively correlated with the quantity of transmissions of the proposal from the leader node to the first node, and the time interval being a time difference between a time of a next transmission of the proposal from the leader node to the follower node and a time of a last transmission of the proposal from the leader node to the follower node; and a retransmission unit, configured to retransmit the proposal to the first node based on the time interval.

According to a third aspect, the present disclosure provides an electronic device, including a processor and a memory. The memory is configured to store a computer program, and the processor is configured to invoke and run the computer program stored in the memory to perform the method in the foregoing first aspect.

According to a fourth aspect, a chip is provided, which is configured to implement the method in various implementations of the foregoing first aspect. Specifically, the chip includes a processor, which is configured to invoke a computer program from a memory and run the computer program, so that a device having the chip installed therein performs the method in the foregoing first aspect.

According to a fifth aspect, a non-transitory computer-readable storage medium is provided, which is configured to store a computer program. The computer program causes a computer to perform the method in the foregoing first aspect.

In summary, in the present disclosure, the leader node in a blockchain system transmits the generated proposal to the N follower nodes in the regional chain system, and records the quantity of transmissions of the proposal from the leader node to each of the N follower nodes; next, the leader node receives the node state information transmitted by the M follower nodes of the N follower nodes, and determines the first node of the N follower nodes not receiving the proposal based on the node state information of each of the M follower nodes, M being a positive integer less than or equal to N; then the leader node obtains the currently recorded quantity of transmissions of the proposal from the leader node to the first node, and determines the time interval before a next transmission of the proposal from the leader node to the first node based on the quantity of transmissions of the proposal from the leader node to the first node, the time interval being positively correlated with the quantity of transmissions of the proposal from the leader node to the first node; and finally, the leader node retransmits the proposal to the first node based on the time interval. In the embodiments of the present disclosure, when retransmitting the proposal to the first node, the leader node determines the time interval before a next transmission of the proposal from the leader node to the first node based on the currently recorded quantity of transmissions of the proposal from the leader node to the first node, the time interval being positively correlated with the quantity of transmissions. In other words, each time the leader node retransmits the proposal to the first node, the leader node determines the time interval before a next transmission of the proposal from the leader node to the first node based on the currently recorded quantity of transmissions of the proposal from the leader node to the first node, the time interval being positively correlated with the quantity of transmissions. For example, during the second retransmission of the proposal to the first node, because the quantity of transmissions of the proposal is 1, a time interval corresponding to the second retransmission may be determined based on 1. During the third retransmission of the proposal to the first node, because the quantity of transmissions of the proposal is 2, a time interval corresponding to the third retransmission may be determined based on 2. Because the quantity of transmissions is positively correlated with the time interval during each retransmission, the time interval becomes larger with the increase of the quantity of transmissions. During the proposal retransmission, the time interval before a next transmission of the proposal is gradually increased, which reduces continuous proposal transmission situations, so that network congestion between the two nodes can be alleviated, thereby ensuring that the proposal can be transmitted to nodes not receiving the proposal as quickly as possible, and occupation of a large part of a network bandwidth is avoided, thereby reducing impact on transmission of the proposal by the leader node to other nodes in a normal network. Therefore, during the proposal retransmission, gradually increasing the time interval before a next transmission of the proposal can improve Byzantine consensus processing in network conditions in which nodes are in a poor network and the nodes are disconnected from the chain and go offline, thereby improving the overall performance of the blockchain system.

### BRIEF DESCRIPTION OF THE DRAWINGS

FIG. 1 is a schematic diagram of a blockchain system.

FIG. 2 is a schematic diagram of proposal transmission in a blockchain system.

FIG. 3 is a schematic diagram of an implementation environment of a data processing method according to an embodiment of the present disclosure.

FIG. 4 is a schematic flowchart of a data transmission method according to an embodiment of the present disclosure.

FIG. 5 is a schematic diagram of updating of consensus state information according to an embodiment of the present disclosure.

FIG. 6 is another schematic diagram of updating of consensus state information according to an embodiment of the present disclosure.

FIG. 7 is a schematic flowchart of a data transmission method according to an embodiment of the present disclosure.

FIG. 8 is still another schematic diagram of updating of consensus state information according to an embodiment of the present disclosure.

FIG. 9 is a schematic diagram of a correspondence between a proposal transmission quantity and a proposal retransmission time interval.

FIG. 10 is a schematic block diagram of a data transmission apparatus according to an embodiment of the present disclosure.

FIG. 11 is a schematic block diagram of an electronic device according to an embodiment of the present disclosure.

### DESCRIPTION OF EMBODIMENTS

Technical solutions in embodiments of the present disclosure are described below with reference to drawings in the embodiments of the present disclosure.

In the embodiments of the present disclosure, “B corresponds to A” indicates that B is associated with A. In an implementation, B may be determined according to A. However, determining A according to B does not mean that B is determined according to only A. Instead, B may be determined according to A and/or other information.

In the description of the present disclosure, unless otherwise stated, “a plurality of” means two or more.

Moreover, to clearly describe the technical solutions in the embodiments of the present disclosure, words such as “first” and “second” are used in the embodiments of the present disclosure to distinguish between same items or similar items whose functions and effects are substantially the same. A person skilled in the art may understand that the words such as “first” and “second” do not limit a number and an execution order, and the words such as “first” and “second” are unnecessarily different.

A data transmission method provided in the embodiments of the present disclosure may be applied to various scenarios such as cloud computing, big data, data transmission, and a blockchain. Through the method, when a leader node in the blockchain transmits a proposal to a node in the blockchain not receiving the proposal, it can be ensured that the proposal is retransmitted as quickly as possible, and occupation of a large part of a network bandwidth is avoided, which improves Byzantine consensus processing in network conditions in which nodes are in a poor network and the nodes are disconnected from the chain and go offline, thereby improving overall performance of the blockchain system.

For ease of understanding of the embodiments of the present disclosure, related concepts involved in the embodiments of the present disclosure are first described:

A cloud technology is a collective name of a network technology, an information technology, an integration technology, a platform management technology, an application technology, and the like based on application of a cloud computing business model. The technologies may form a resource pool for use on demand, which is flexible and convenient. A cloud computing technology becomes an important support. Backend services of a technology network system require a lot of computing and storage resources, such as a video website, a picture website, and more portal websites. With the rapid development and application of the Internet industry, each item may have its own identification mark in the future, and the identification marks need to be transmitted to a backend system for logical processing. Data of different levels is processed separately, and all kinds of industry data require a strong system support, which can be achieved only through the cloud computing.

Big data refers to a collection of data that cannot be captured, managed, and processed by using software tools within a specific time range. Big data is a massive, high-growth, and diverse information asset that needs a new processing mode to have stronger decision-making power, insight and discovery capabilities, and process optimization capabilities. With the advent of the cloud era, big data has attracted increasing attention. Big data needs special technologies to effectively process substantial data within a tolerable elapsed time. Technologies applied to big data include a massively parallel processing database, data mining, a distributed file system, a distributed database, a cloud computing platform, the Internet, and an extensible storage system.

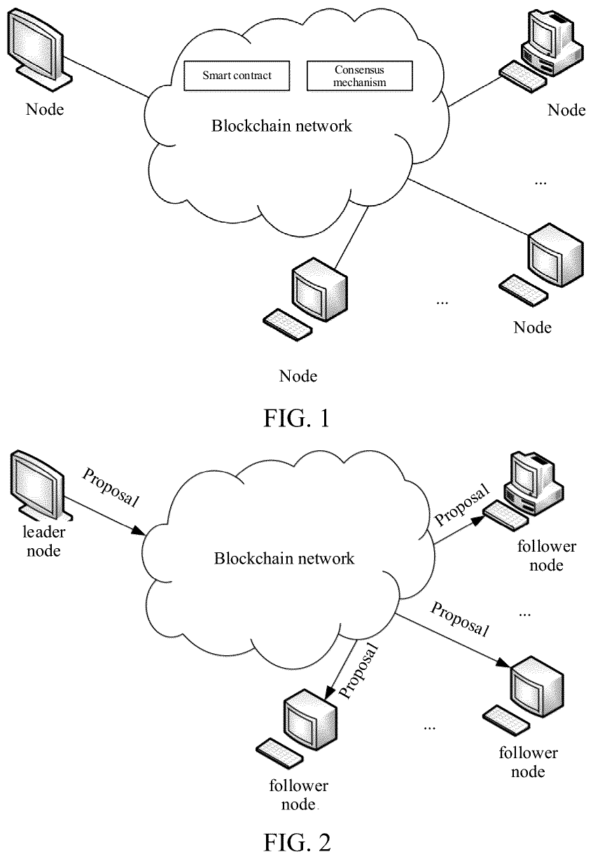

As shown in FIG. 1, a blockchain technology is a distributed database, and is characterized by decentralization, tamper resistance, and extensibility. In a blockchain system, all data is stored in a block, and newly written data forms a new block and is added to an end chain of the current blockchain. Each block, while storing data, stores a value that uniquely corresponds to all data recorded in a previous block, which is typically a hash value of all of the data. If someone attempts to modify the data in the previous block, the value stored in a current block is inconsistent, resulting in a failure in forming a chain. Therefore, a blockchain system may be considered as a system in which computers on a distributed network that are not completely trusted by each other jointly maintain a set of traceable and tamper-resistant chain data by using a consensus rule. Because the data and the platform are not exclusively controlled by any mechanism, the blockchain system may be considered as a decentralized basic computing framework which is highly secure, highly reliable, and trustworthy.

A consensus mechanism refers to validating and confirming transactions within a very short period of time through voting of special nodes. For a transaction, if a plurality of irrelevant nodes can reach a consensus, it may be considered that the entire network can reach a consensus on the transaction. In other words, a consensus mechanism is equivalent to a voting rule. Different consensus mechanisms are equivalent to different voting rules. For example, in some voting rules, a majority vote is required, and in some voting rules, a two-thirds vote is required. All nodes have the right to vote. Each time a result needs to be determined, all of the nodes participate in the voting, and perform voting according to different voting rules (consensus mechanisms), to select a node. All of nodes attempt to reach a consensus through the consensus mechanism. After current voting, a result determined by a selected node is considered to be valid, while results determined by other nodes are invalid.

Byzantine fault tolerance (BFT) is a consensus mechanism derived from the Byzantine failures, which aims to resolve a problem about how nodes reach a consensus in an untrusted environment.

Currently, Byzantine consensus processing in a mainstream blockchain system mainly includes 3 stages: proposal, vote (prevote), and precommit. The three stages may have different names in different Byzantine algorithms, but have the same core processing procedure. A core of consensus reaching is as follows: A leader node generates a proposal through packaging, and then broadcasts the proposal to follower nodes. After receiving the proposal, the follower nodes validate and vote for the proposal.

The embodiments of the present disclosure mainly involve the first stage, i.e., a process in which a leader node transmits a generated proposal to other follower nodes.

As shown in FIG. 2, in a blockchain system, a leader node transmits a generated proposal to follower nodes in the blockchain. However, the transmission of the proposal may fail due to an unstable network, packet losses, disconnection, and the like. In this case, the leader node needs to retransmit the proposal to nodes not receiving the proposal, to ensure that the consensus processing of a regional chain system runs stably and continuously.

Currently, to ensure consensus performance of the regional chain system, the leader node usually retransmits the proposal to the nodes in the regional chain not receiving the proposal every one second. However, in typical Byzantine consensus projects, a proposal includes a large quantity of transactions, resulting in a large amount of data of the proposal, which reaches at least tens of megabytes (m). For a node that is in a poor network condition, goes offline, or shut down, a proposal is retransmitted once approximately every one second. Because the node is in the unstable network or even is disconnected, continuously transmitting the proposal causes network congestion between both nodes. As a result, the proposal cannot be retransmitted to the node in time. In addition, if a leader node continuously retransmits a proposal to a node in an unstable network, a large part of a network bandwidth of the leader node is occupied, which affects transmission of the proposal from the leader node to other nodes in a normal network, thereby degrading the overall performance of the blockchain system.

To resolve the foregoing technical problem, in the embodiments of the present disclosure, when a leader node transmits a proposal to N follower nodes in a blockchain, the leader node records a quantity of transmissions of the proposal from the leader node to each of the N follower nodes. Thus, after the leader node determines a first node not receiving the proposal from the N follower nodes based on node state information of the follower nodes, the leader node determines a time interval before a next transmission of the proposal from the leader node to the first node based on the currently recorded quantity of transmissions of the proposal from the leader node to the first node, the time interval being positively correlated with the quantity of transmissions. To be specific, a large quantity of transmissions indicates a larger time interval before a next transmission of the proposal. During the proposal retransmission, the time interval before a next transmission of the proposal is gradually increased, which reduces continuous proposal transmission situations, so that network congestion between both nodes can be alleviated, thereby ensuring that the proposal can be transmitted to the nodes not receiving the proposal as quickly as possible, and occupation of a large part of a network bandwidth is avoided, thereby reducing impact on transmission of the proposal from the leader node to other nodes in a normal network. Therefore, during the proposal retransmission, gradually increasing the time interval before a next transmission of the proposal can improve Byzantine consensus processing in network conditions in which nodes are in a poor network and the nodes are disconnected from the chain and go offline, thereby improving the overall performance of the blockchain system.

An application scenario of the embodiments of the present disclosure is described below.

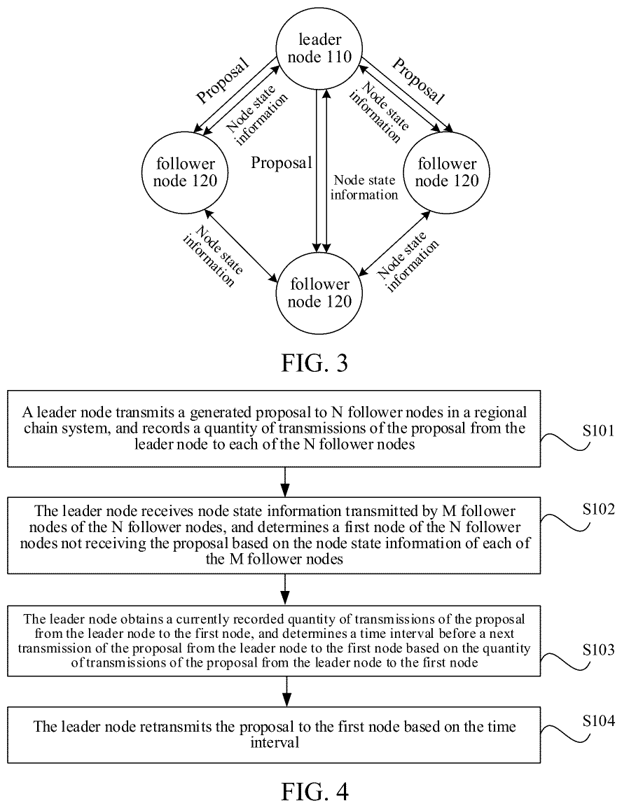

FIG. 3 is a schematic diagram of an implementation environment of a data processing method according to an embodiment of the present disclosure. As shown in FIG. 1, the implementation environment includes a leader node 110 and N follower nodes 120, and the leader node 110 and the N follower nodes 120 form a blockchain system.

In the blockchain system formed by the leader node 110 and the N follower nodes 120, all nodes are communicatively connected to each other, and each node broadcasts node state information thereof to other nodes regularly.

In some embodiments, the leader node 110 packages transactions into a proposal, and broadcasts the proposal to the N follower nodes 120.

Specific forms of the leader node 110 and the N follower nodes 120 are not limited in this embodiment of the present disclosure.

In some embodiments, at least one of the leader node 110 and the N follower nodes 120 is a terminal device. The terminal device may be at least one of a smartphone, a camera, a desktop computer, a tablet computer, a moving picture experts group audio layer IV (MP4) player, and a laptop computer.

In some embodiments, at least one of the leader node 110 and the N follower nodes 120 is a server. The server may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

In an embodiment of the present disclosure, the leader node 120 transmits the generated proposal to the N follower nodes in a regional chain, and records a quantity of transmissions of the proposal from the leader node 120 to each of the N follower nodes. Next, the leader node 120 receives node state information transmitted by M follower nodes of the N follower nodes, and determines a first node of the N follower nodes not receiving the proposal based on the node state information of each of the M follower nodes. Then, the leader node 120 obtains a currently recorded quantity of transmissions of the proposal from the leader node 120 to the first node, and determines a time interval before a next transmission of the proposal from the leader node 120 to the first node based on the quantity of transmissions of the proposal from the leader node 120 to the first node, the time interval being positively correlated with the quantity of transmissions. finally, the leader node 120 retransmits the proposal to the first node based on the time interval. During the proposal retransmission, the leader node 120 gradually increases the time interval before a next transmission of the proposal, which reduces continuous proposal transmission situations, so that network congestion between both nodes can be alleviated, thereby ensuring that the proposal can be transmitted to the nodes not receiving the proposal as quickly as possible, and occupation of a large part of a network bandwidth is avoided, thereby reducing impact on transmission of the proposal from the leader node to other nodes in a normal network. Therefore, during the proposal retransmission, gradually increasing the time interval before a next transmission of the proposal can improve Byzantine consensus processing in network conditions in which nodes are in a poor network and the nodes are disconnected from the chain and go offline, thereby improving the overall performance of the blockchain system.

The technical solutions in the embodiments of the present disclosure are described in detail below by using some embodiments. The following embodiments may be combined with each other, and same or similar concepts or processes may not be repeated in some embodiments.

FIG. 4 is a schematic flowchart of a data transmission method according to an embodiment of the present disclosure. This embodiment of the present disclosure may be performed by the leader node shown in FIG. 3. As shown in FIG. 3, the blockchain system includes one leader node and N follower nodes.

As shown in FIG. 4, the data processing method in this embodiment of the present disclosure includes the following operations:

S101: The leader node transmits a generated proposal to the N follower nodes in a regional chain system, and records a quantity of transmissions of the proposal from the leader node to each of the N follower nodes.

N is a positive integer.

The blockchain system in this embodiment of the present disclosure includes N+1 nodes, and each of the N+1 nodes broadcasts node state information thereof to other nodes regularly. To ensure that the other nodes can receive the state in time, the state is usually broadcast once every one second. Each node further maintains the node state information of the other nodes, and updates the states of the other nodes maintained therein based on latest node state information transmitted by the other nodes.

Specific content included in the node state information of the nodes is not limited in this embodiment of the present disclosure.

In some embodiments, the node state information includes an identifier of the node and a height value of the node in the blockchain system. The height value of the node in the blockchain system may be understood as a position of the node in the blockchain system.

After a node of the N+1 nodes becomes a leader node through election or the like, the other N nodes may be understood as follower nodes of the leader node. In this case, the leader node packages transactions into a proposal, and transmits the proposal to each of the N follower nodes based on the node state information of each of the N follower nodes currently maintained in the leader node. For example, the leader node transmits the proposal to the follower node according to an identifier and a height value of the follower node.

In this embodiment of the present disclosure, to facilitate subsequent retransmission of the proposal from the leader node to a follower node of the N follower nodes not receiving the proposal, the leader node records the quantity of transmissions of the proposal from the leader node to each of the N follower nodes.

In other words, each time the leader node transmits the proposal to a follower node, the leader node increases the quantity of transmissions corresponding to the follower node by 1. In this way, the leader node can determine the time interval before a next transmission of the proposal from the leader node to the follower node next time based on the quantity of transmissions corresponding to the follower node. For example, a large quantity of transmissions indicates a larger time interval before a next transmission of the proposal. In this way, problems that network congestion of a follower node in an unstable network becomes severer, a large part of a network bandwidth of the leader node is occupied, and receiving of the proposal by other nodes in a normal network is affected as a result of the leader node frequently transmitting the proposal to the follower node can be prevented. In other words, in this embodiment of the present disclosure, during the proposal retransmission, the leader node gradually increases the time interval before a next transmission of the proposal, which reduces continuous proposal transmission situations, so that network congestion between both nodes can be alleviated, thereby ensuring that the proposal can be transmitted to the nodes not receiving the proposal as quickly as possible, and occupation of a large part of a network bandwidth is avoided, thereby reducing impact on transmission of the proposal from the leader node to other nodes in a normal network. Therefore, during the proposal retransmission, gradually increasing the time interval before a next transmission of the proposal can improve Byzantine consensus processing in network conditions in which nodes are in a poor network and the nodes are disconnected from the chain and go offline, thereby improving the overall performance of the blockchain system.

A specific manner in which the leader node records the quantity of transmissions of the proposal from the leader node to each of the N follower nodes is not limited in this embodiment of the present disclosure.

In some embodiments, the leader node records the quantity of transmissions of the proposal from the leader node to each of the N follower nodes through the following Table 1:

TABLE 1

| Identifier of a follower node | Quantity of transmissions |
|---|---|
| Identifier of a follower node 1 | a1 |
| Identifier of a follower node 2 | a2 |
| . . . | . . . |
| Identifier of a follower node N | an |

As shown in the foregoing Table 1, each time the leader node transmits the proposal to a follower node, a quantity of transmissions corresponding to the node in Table 1 is increased by 1.

In some embodiments, the leader node stores consensus state information of each of the N follower nodes. The consensus state information of the node includes a quantity of transmissions of the proposal from the leader node to the node. In other words, for each of the N follower nodes, the leader node records, for each of the N follower nodes through the consensus state information of the follower node, the quantity of transmissions of the proposal from the leader node to the follower node.

In this embodiment of the present disclosure, representations of the consensus state information of all of the N follower nodes maintained in the leader node are substantially the same. The consensus state information of an i^{th} follower node of the N follower nodes maintained in the leader node is used as an example. The consensus state information of the i^{th} follower node includes an identifier of the i^{th} follower node and a quantity of transmissions of the proposal from the leader node to the i^{th} follower node (i.e., a proposal transmission quantity).

For example, the consensus state information of the i^{th} follower node is shown in Table 2.

TABLE 2
Consensus state information

Identifier of the i^{th} follower node
Proposal transmission quantity
. . .

As shown in Table 2, each time the leader node transmits the proposal to the i^{th} follower node, the quantity of transmissions corresponding to the i^{th} node in Table 2 is increased by 1.

In some embodiments, the consensus state information of the i^{th} follower node shown in Table 2 may further include other information related to the i^{th} follower node, which is not limited herein.

In this embodiment of the present disclosure, after the leader node transmits the generated proposal to the N follower nodes in the blockchain system, the leader node performs the following operation S102.

S102: The leader node receives node state information transmitted by M follower nodes of the N follower nodes, and determines a first node of the N follower nodes not receiving the proposal based on the node state information of each of the M follower nodes.

M is a positive integer less than or equal to N.

It may be learned from the above that each node in the blockchain system broadcasts the node state information thereof to other nodes regularly. In this way, after the leader node transmits the generated proposal to the N follower nodes, the leader node can receive the node state information transmitted by the other nodes in the blockchain system.

However, due to reasons such as an unstable network or some nodes in the blockchain system having being offline, the leader node receives the node state information transmitted by only the M follower nodes of the N follower nodes. The leader node determines the first node of the N follower nodes not receiving the proposal based on the node state information of each of the M follower nodes.

In this embodiment of the present disclosure, a specific manner in which the leader node determines the first node of the N follower nodes not receiving the proposal based on the node state information of each of the M follower nodes includes but is not limited to the following:

Manner 1: If M is less than N, it indicates that the M follower nodes of the N follower nodes can be communicatively connected to the leader node and N-M nodes may not be communicatively connected to the leader node. In this case, after transmitting the proposal to the N follower nodes, when receiving the node state information transmitted by only the M follower nodes, the leader node may determine follower nodes of the N follower nodes other than the M follower nodes as follower nodes not receiving the proposal. For ease of description, in this embodiment of the present disclosure, the follower nodes not receiving the proposal are denoted as a first node. In this case, in the blockchain system, there are N-M first nodes not receiving the proposal.

Manner 2: The node state information of each follower node in the blockchain system regularly transmitted by the follower node includes a current proposal hash value of the follower node. The proposal hash value may be understood as identification information indicating that the proposal is currently received by the follower node. The proposal hash value generally includes two types of values: null and a hash value of the proposal transmitted by the leader node. In this way, the leader node can determine the first node not receiving the proposal from the N follower nodes based on the hash value in the node state information of each of the M follower nodes.

In this embodiment of the present disclosure, representations of the node state information of all of the M follower nodes are substantially the same. The node state information of the i^{th} follower node of the M follower nodes is used as an example. The node state information of the i^{th} follower node includes an identifier of the i^{th} follower node and a current proposal hash value of the i^{th} follower node.

For example, the node state information of the i^{th} follower node is shown in Table 3.

TABLE 3
Node state information

Node identifier
Proposal hash value
. . .

In this embodiment of the present disclosure, for the i^{th} follower node of the N follower nodes, the leader node transmits the proposal to the i^{th} follower node. If the i^{th} follower node receives the proposal transmitted by the leader node, the i^{th} follower node sets the proposal hash value in the node state information of the i^{th} follower node to the hash value of the proposal transmitted by the leader node. If the i^{th} follower node does not receive the proposal transmitted by the leader node due to reasons such as an unstable network, the i^{th} follower node sets the proposal hash value in the node state information of the i^{th} follower node to null (or 0), or the i^{th} follower node does not process the current proposal hash value of the i^{th} follower node when an initial value of the proposal hash value is null (or 0). Next, the i^{th} follower node transmits the current node state information of the i^{th} follower node to the leader node when a transmission time of the node state information arrives. In some embodiments, the i^{th} follower node further transmits the node state information to other follower nodes in addition to the leader node.

Based on the above, the leader node can receive the node state information transmitted by the M follower nodes, thereby determining the first node of the N follower nodes not receiving the proposal based on the proposal hash value in the node state information of each of the M follower nodes.

In this embodiment of the present disclosure, manners in which the leader node determines the first node of the N follower nodes not receiving the proposal based on the proposal hash value in the node state information of each of the M follower nodes include at least the following two manners:

Manner 1: The leader node determines the first node directly based on the proposal hash values in the node state information of the M follower nodes. For example, for the i^{th} follower node of the M follower nodes, if the proposal hash value in the node state information of the i^{th} follower node is null, it is determined that the i^{th} follower node does not receive the proposal transmitted by the leader node, and therefore the i^{th} follower node is determined as the first node.

Because the follower nodes in the blockchain system receive only the proposal transmitted by the leader node, if the proposal hash value in the node state information of the i^{th} follower node is not null, it indicates that the proposal hash value in the node state information of the i^{th} follower node is the hash value of the proposal transmitted by the leader node. Therefore, it may be determined that the i^{th} follower node has received the proposal transmitted by the leader node, and the leader node does not need to retransmit the proposal to the i^{th} follower node.

Manner 2: The consensus state information in this embodiment of the present disclosure further includes a proposal hash value. The leader node updates the consensus state information maintained in the leader node by using the received node state information, and determines the first node not receiving the proposal based on the proposal hash value in the consensus state information.

In this case, before the leader node determines the first node of the N follower nodes not receiving the proposal based on the node state information of each of the M follower nodes in S102, the leader node updates, for each of the M follower nodes, the proposal hash value in the consensus state information of the follower node based on the current proposal hash value in the node state information of the follower node.

In this embodiment of the present disclosure, representations of the consensus state information of all of the follower nodes maintained in the leader node is substantially the same. The i^{th} follower node is used as an example. The consensus state information of the i^{th} follower node includes the identifier of the i^{th} follower node, the quantity of transmissions of the proposal from the leader node to the i^{th} follower node (that is, a proposal transmission quantity), and the proposal hash value.

For example, the consensus state information of the i^{th} follower node is shown in Table 4.

TABLE 4
Consensus state information

Node identifier
Proposal transmission quantity
Proposal hash value
. . .

In this embodiment of the present disclosure, as shown in Table 3, the node state information of the i^{th} follower node includes the current proposal hash value of the i^{th} follower node, and the consensus state information of the i^{th} follower node is shown in Table 4. After the leader node receives the node state information of the i^{th} follower node shown in Table 3, the leader node updates, by using the proposal hash value in the received node state information of the i^{th} follower node, the proposal hash value in the consensus state information of the i^{th} follower node maintained in the leader node.

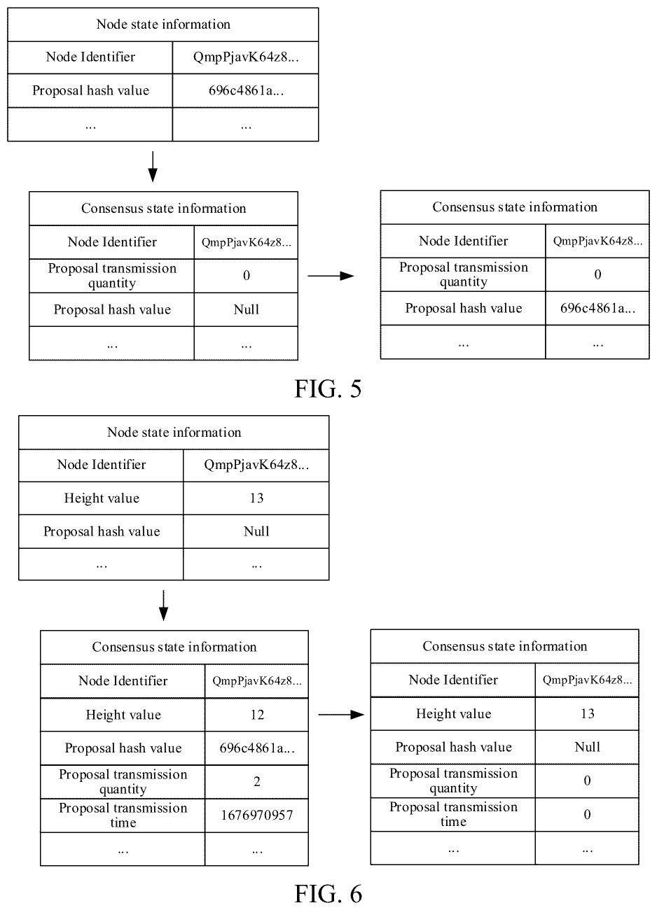

For example, as shown in FIG. 5, a proposal hash value in the consensus state information of the i^{th} follower node maintained in the leader node at a moment to is null, and the leader node transmits the proposal to the i^{th} follower node at a moment t1. The leader node receives the node state information transmitted by the i^{th} follower node at a moment t2. A proposal hash value in the node state information is 696c4861a. In this case, the leader node updates the proposal hash value in the consensus state information of the i^{th} follower node maintained therein, that is, updates null to 696c4861a.

According to the foregoing method, the leader node may update, for each of the M follower nodes, the proposal hash value in the consensus state information of the follower node based on the proposal hash value in the node state information of the follower node.

In this case, the leader node may determine the first node based on the updated proposal hash value in the consensus state information of each of the M follower nodes.

For example, for each of the M follower nodes, if the updated proposal hash value in the consensus state information of the follower node is null, it is determined that the follower node does not receive the proposal transmitted by the leader node, and it is determined that the follower node is the first node.

If the updated proposal hash value in the consensus state information of the follower node is non-null, it is determined that the follower node receives the proposal transmitted by the leader node, and the leader node no longer retransmits the proposal to the follower node.

In the manner 2, the leader node may determine, based on the proposal hash values in the node state information transmitted by the M follower nodes, the first node of the M follower nodes not receiving the proposal. In some embodiments, if M is less than N, the leader node further determines follower nodes of the N follower nodes other than the M follower nodes as the first node.

In this way, the leader node can accurately determine the first node of the N follower nodes not receiving the proposal based on the foregoing operations. After determining the first node of the N follower nodes not receiving the proposal based on the foregoing operations, the leader node performs the following operation S103.

S103: The leader node obtains a currently recorded quantity of transmissions of the proposal from the leader node to the first node, and determines a time interval before a next transmission of the proposal from the leader node to the first node based on the quantity of transmissions of the proposal from the leader node to the first node.

The time interval is positively correlated with the quantity of transmissions of the proposal from the leader node to the first node, and the quantity of transmissions is also referred to as a quantity of transmissions corresponding to the first node. The time interval may be understood as a time difference between a time of a next transmission of the proposal from the leader node to the follower node and a time of a last transmission of the proposal from the leader node to the follower node. In other words, the time interval is a time difference between a time of a next transmission of the proposal from the leader node to the follower node and a time of the last transmission of the proposal from the leader node to the follower node.

The expression “positively correlated with” means that a dependent variable increases as an independent variable increases. In other words, the two variables have the same change trend. When one variable decreases or increases, the other variable decreases or increases. Based on the above, that the time interval is positively correlated with the quantity of transmissions of the proposal from the leader node to the first node means that a larger quantity of transmissions of the proposal from the leader node to the first node indicates a larger time interval and that a smaller quantity of transmissions of the proposal from the leader node to the first node indicates a shorter time interval.

It may be learned from the foregoing description that, in this embodiment of the present disclosure, the leader node has the quantity of transmissions of the proposal from the leader node to each of the N follower nodes stored therein. In this way, after determining the first node of the N follower nodes not receiving the proposal based on the foregoing operation S102, the leader node obtains the currently recorded quantity of transmissions of the proposal from the leader node to the first node, and determines the time interval before a next transmission of the proposal from the leader node to the first node based on the quantity of transmissions corresponding to the first node. That the time interval is positively correlated with the quantity of transmissions corresponding to the first node means that a larger quantity of transmissions of the proposal from the leader node to the first node indicates a larger time interval before a next transmission of the proposal from the leader node to the first node. In this way, the time interval before a retransmission of the proposal can be gradually increased, which reduces continuous proposal transmission situations, so that network congestion between both nodes can be alleviated, thereby ensuring that the proposal can be transmitted to the nodes not receiving the proposal as quickly as possible, and occupation of a large part of a network bandwidth is avoided, thereby reducing impact on transmission of the proposal from the leader node to other nodes in a normal network. Therefore, during the proposal retransmission, gradually increasing the time interval before a next transmission of the proposal can improve Byzantine consensus processing in network conditions in which nodes are in a poor network and the nodes are disconnected from the chain and go offline, thereby improving the overall performance of the blockchain system.

A manner in which the leader node obtains the currently recorded quantity of transmissions of the proposal from the leader node to the first node is not limited in this embodiment of the present disclosure.

In some embodiments, the leader node records the quantity of transmissions of the proposal from the leader node to each of the N follower nodes in the form of the foregoing Table 1. In this way, after determining the first node based on the foregoing operations, the leader node obtains the quantity of transmissions corresponding to the first node from the foregoing Table 1 based on the identifier of the first node.

In some embodiments, as shown in Table 2 and Table 4, if the leader node records the quantity of transmissions of the proposal from the leader node to each of the N follower nodes by maintaining the consensus state information of each of the N follower nodes, after determining the first node based on the foregoing operations, the leader node obtains the quantity of transmissions corresponding to the first node from the consensus state information of the first node shown in the foregoing Table 2 or Table 4 based on the identifier of the first node,
the leader node obtains the currently recorded quantity of transmissions of the proposal from the leader node to the first node, and determines the time interval before a next transmission of the proposal from the leader node to the first node based on the quantity of transmissions corresponding to the first node.

A specific manner in which the leader node determines the time interval before a next transmission of the proposal from the leader node to the first node based on the quantity of transmissions corresponding to the first node is not limited in this embodiment of the present disclosure, as long as the determined time interval before a next transmission of the proposal to the first node is positively correlated with the quantity of transmissions corresponding to the first node.

In some embodiments, the time interval before a next transmission of the proposal to the first node is obtained by using a first value as a base number and the quantity of transmissions corresponding to the first node an index, the first value being a positive number greater than 1.

For example, the leader node determines the time interval before a next transmission of the proposal from the leader node to the first node by using the following formula (1):

$$∇ t = {n}^{c} . \qquad ( 1 )$$

n is a positive number of the first value, c is the quantity of transmissions, and ∇t is the time interval before a next transmission of the proposal.

A specific value of the foregoing first value n is not limited in this embodiment of the present disclosure. In an example, n is 2.

In some embodiments, the leader node may determine the time interval before a next transmission of the proposal from the leader node to the first node through the following operation S103-A.

S103-A: The leader node determines the time interval before a next transmission of the proposal from the leader node to the first node based on the quantity of transmissions corresponding to the first node and a time interval between transmissions, among the quantity of transmissions corresponding to the first node, of the proposal from the leader node to the first node.

In this implementation, each time the leader node retransmits the proposal to the first node, the leader node needs to determine a time interval before a retransmission of the proposal. In other words, each transmission of the quantity of transmissions corresponding to the first node corresponds to one time interval. Based on the above, the leader node may determine the time interval before a next transmission of the proposal from the leader node to the first node based on the quantity of transmissions corresponding to the first node and the time interval between transmissions, among the quantity of transmissions, of the proposal from the leader node to the first node.

For example, it is assumed that the leader node transmits the proposal to the first node three times, and time intervals before the three transmissions of the proposal are respectively 0, ∇t1, and ∇t2. The time interval before a next transmission of the proposal may be understood as a time interval between a time of a last transmission of the proposal from the leader node to the first node and a time of a next transmission of the proposal to the first node. In this way, the leader node can determine the time interval before a next transmission of the proposal from the leader node to the first node based on the quantity of transmissions of the proposal from the leader node to the first node (which is 3) and the time intervals 0, ∇t1, and ∇t2 corresponding to the three transmissions.

A specific manner in which the leader node determines the time interval before a next transmission of the proposal from the leader node to the first node based on the quantity of transmissions corresponding to the first node and the time interval between transmissions, among the quantity of transmissions corresponding to the first node, of the proposal from the leader node to the first node. is not limited in this embodiment of the present disclosure.

In some embodiments, the leader node determines a product of the quantity of transmissions corresponding to the first node and the time interval before the last transmission of the proposal from the leader node to the first node as the time interval before a next transmission of the proposal from the leader node to the first node. Still referring to the foregoing example, assuming that the time interval before a last transmission of the proposal from the leader node to the first node is ∇t2, the leader node determines 3*∇t2 as the time interval before a next transmission of the proposal from the leader node to the first node.

In some embodiments, S103-A includes the following examples:

Example 1: If the quantity of transmissions corresponding to the first node is greater than or equal to 2, the leader node determines the time interval before a next transmission of the proposal from the leader node to the first node based on a first time interval before the last transmission of the proposal from the leader node to the first node and a second time interval before a transmission before the last transmission of the proposal from the leader node to the first node.

For example, the leader node transmits the proposal to the first node a total of three times. At the first time, the leader node transmitted the proposal to each follower node in the blockchain through broadcasting at a time t1. Therefore, it is determined that a time interval ∇t0 before a first transmission of the proposal from the leader node to the first node is 0. If the leader node determines that the first node does not receive the proposal based on the foregoing operation, the leader node retransmits the proposal to the first node after a first time interval ∇t1 since the time of the first transmission of the proposal (i.e., the time t1). If the leader node determines that the first node still does not receive the proposal after the second transmission of the proposal to the first node, the leader node retransmits the proposal to the first node after a second time interval ∇t2 since the time of the second transmission of the proposal. It may be learned that the time intervals before transmissions of the three proposals from the leader node to the first node are respectively ∇t0, ∇t1, and ∇t2. If the leader node determines that the first node still does not receive the proposal after the third transmission of the proposal from the leader node to the first node, the leader node determines a time interval ∇t3 before a next transmission (i.e., a fourth transmission) of the proposal from the leader node to the first node based on the time interval ∇t2 before the last transmission (i.e., a third transmission) of the proposal from the leader node to the first node and the time interval ∇t1 before a transmission before the last transmission (i.e., a second transmission) of the proposal from the leader node to the first node. For ease of description, in this embodiment of the present disclosure, the time interval before the last transmission of the proposal from the leader node to the first node is denoted as a first time interval, and the time interval before the transmission before the last transmission of the proposal from the leader node to the first node is denoted as a second time interval.

A specific manner in which the leader node determines the time interval before a next transmission of the proposal from the leader node to the first node based on the first time interval before a last transmission of the proposal from the leader node to the first node and the second time interval before a transmission before the last transmission of the proposal from the leader node to the first node is not limited in this embodiment of the present disclosure.

In an example, the leader node determines a sum of the first time interval and the second time interval as the time interval before a next transmission of the proposal from the leader node to the first node.

For example, the leader node determines the time interval before a next transmission of the proposal from the leader node to the first node based on the following formula (2):

$$F ( n ) = F ( n - 1 ) + F ( n - 2 ) ( n \geq 2 ) . \qquad ( 2 )$$

n is the quantity of transmissions of the proposal from the leader node to the first node, F(n) is a time interval before an n^{th} transmission (i.e., a next transmission) of the proposal from the leader node to the first node, F(n−1) is a time interval before an (n−1)^{th} transmission (i.e., the last transmission) of the proposal from the leader node to the first node, and F(n−2) is a time interval before an (n−2)^{th} transmission (i.e., a transmission before the last transmission) of the proposal from the leader node to the first node. F(n) is used in the formula to represent the time interval ∇t.

In an example, the leader node adds up the first time interval and the second time interval, and then adds a preset value to the sum, to obtain the time interval before a next transmission of the proposal from the leader node to the first node.

Example 2: If the quantity of transmissions corresponding to the first node is equal to 1, the first time interval before the last transmission of the proposal from the leader node to the first node is determined as the time interval before a next transmission of the proposal from the leader node to the first node.

Still referring to foregoing example, if the leader node transmits the proposal to the first node once. At the first time, the leader node transmitted the proposal to each follower node in the blockchain through broadcasting at a time t1. Therefore, it is determined that a time interval ∇t0 before a first transmission of the proposal from the leader node to the first node is one second. Therefore, the leader node may determine that the time interval before a next transmission (i.e., a second transmission) of the proposal from the leader node to the first node is also one second.

In some embodiments, the leader node may alternatively determine the proposal retransmission time interval through a Fibonacci sequence. The Fibonacci sequence, also referred to as a golden section sequence, refers to a sequence as follows: 1, 1, 2, 3, 5, 8, 13, . . . . Mathematically, the Fibonacci sequence is defined through recursion as follows: F(0)=0, F(1)=1, F(n)=F(n−1)+F(n−2) (n≥2, n∈N*). In this embodiment of the present disclosure, the time interval F(n) before an n^{th} retransmission of the proposal from the leader node to the first node may be determined through recursion by using the Fibonacci sequence.

In this embodiment of the present disclosure, in the foregoing manner in which the leader node determines the first node, for a follower node of the N follower nodes, if a proposal hash value of the follower node is always null, it indicates that the follower node receives no proposal at the height. Therefore, the follower node is determined as a first node, and the proposal is retransmitted to the first node. However, the retransmission is not performed after a fixed time interval (e.g., one second). Instead, a quantity of transmissions to the same height is substituted into the Fibonacci sequence formula, to determine the time interval before a next transmission of the proposal. After the time interval, the proposal is retransmitted to the first node.

For example, if the height value of the first node in the blockchain is constant, for example, is always 1, but the proposal hash value thereof is always null, time intervals before retransmissions of the proposal from the leader node to the first node are one second, one second, two seconds, three seconds, five seconds, eight seconds, . . . . The time interval is gradually increased, to ensure that a network bandwidth is not occupied as a result of frequent proposal transmission.

After determining the time interval before a next transmission of the proposal from the leader node to the first node based on the foregoing operation S103, the leader node performs the following operation S104.

S104: The leader node retransmits the proposal to the first node based on the time interval.

After determining the time interval before a next transmission of the proposal from the leader node to the first node based on the foregoing operation, the leader node retransmits the proposal to the first node based on the time interval before a next retransmission of the proposal from the leader node to the first node when the time interval arrives.

In some embodiments, to help the leader node determine the time of the retransmission of the proposal to the first node, the consensus state information maintained in the leader node further includes a transmission time of a last transmission of the proposal from the leader node to the follower node. In other words, the leader node records a time of a latest transmission of the proposal to the follower node in the consensus state information of the follower node.

The i^{th} follower node is used as an example, the consensus state information of the i^{th} follower node includes an identifier of the i^{th} follower node, a quantity of transmissions of the proposal from the leader node to the i^{th} follower node (i.e., a proposal transmission quantity), a transmission time of a last transmission of the proposal from the leader node to the i^{th} follower node (i.e., a proposal transmission time), and the like.

For example, the consensus state information of the i^{th} follower node is shown in Table 5.

TABLE 5
Consensus state information

Node identifier
Proposal transmission quantity
Proposal hash value
Proposal transmission time
. . .

Based on the consensus state information shown in the foregoing Table 5, S104 includes the following operations S104-A1 to S104-A3:

S104-A1: The leader node obtains the transmission time of the proposal from the leader node to the first node from the consensus state information of the first node.

S104-A2: The leader node determines a first time difference between a current time and the proposal transmission time corresponding to the first node.

S104-A3: The leader node retransmits the proposal to the first node if the first time difference is greater than or equal to the time interval.

In this embodiment, when determining the time interval before a next transmission of the proposal from the leader node to the first node based on the foregoing operation, the leader node obtains the transmission time of the last transmission of the proposal from the leader node to the first node from the consensus state information of the first node, and determines the first time difference between the current time and the proposal transmission time corresponding to the first node. If the first time difference is less than the foregoing time interval, the leader node waits, and temporarily does not transmit the proposal to the first node. If the first time difference is greater than or equal to the foregoing determined time interval, the leader node retransmits the proposal to the first node, thereby reducing continuous proposal transmission situations.

In this embodiment of the present disclosure, after retransmitting the proposal to the first node, the leader node increases the quantity of transmissions of the proposal in the consensus state information of the first node by 1, and updates the proposal transmission time in the consensus state information of the first node to the current time.

In some embodiments, the node state information includes a height value of the follower node in the blockchain system at a current moment, and correspondingly, the consensus state information of the follower node further includes a height value of the follower node. The height value may be understood as a position of the node in the blockchain. In this case, when the leader node updates the consensus state information of the follower node based on the node state information of the follower node, the height value in the consensus state information is further updated.

The i^{th} follower node is used as an example. The node state information of the i^{th} follower node includes an identifier of the i^{th} follower node, a height value, and a proposal hash value at the height value.

For example, the node state information of the i^{th} follower node is shown in Table 6:

TABLE 6
Node state information

Node identifier
Height value
Proposal hash value at a height value
. . .

In this embodiment of the present disclosure, the consensus state information of the i^{th} follower node maintained in the leader node includes an identifier of the i^{th} follower node, a quantity of transmissions of the proposal from the leader node to the i^{th} follower node (i.e., a proposal transmission quantity), a transmission time of the last transmission of the proposal from the leader node to the i^{th} follower node (i.e., a proposal transmission time), a height value of the i^{th} follower node, a proposal hash value received at the height value, and the like.

For example, the consensus state information of the i^{th} follower node is shown in Table 7.

TABLE 7
Consensus state information

Node identifier
Proposal transmission quantity
Height value
Proposal hash value at a height value
Proposal transmission time
. . .

In this embodiment of the present disclosure, as shown in Table 6, the node state information of the i^{th} follower node includes a current height value of the i^{th} follower node and a proposal hash value received at the height value. The consensus state information of the i^{th} follower node is shown in Table 7. After the leader node receives the node state information of the i^{th} follower node shown in Table 6, the leader node updates, by using the height value and the proposal hash value in the received node state information of the i^{th} follower node, the height value and the proposal hash value in the consensus state information of the i^{th} follower node maintained in the leader node.

In some embodiments, for the i^{th} follower node of the M follower nodes, if the height value in the node state information of the i^{th} follower node is inconsistent with the height value in the consensus state information of the i^{th} follower node, the height value in the consensus state information of the i^{th} follower node is updated to the height value in the node state information, and the quantity of transmissions and the transmission time are not updated.

In some embodiments, for the i^{th} follower node of the M follower nodes, if the height value in the node state information of the i^{th} follower node is inconsistent with the height value in the consensus state information of the i^{th} follower node, the height value in the consensus state information of the i^{th} follower node is updated to the height value in the node state information, and the quantity of transmissions and the transmission time in the consensus state information of the i^{th} follower node are reset to 0.

For example, as shown in FIG. 6, consensus state information of the i^{th} follower node maintained in the leader node at a moment to includes the following: a height value of 12, a proposal hash value of 696c4861a, a quantity of transmissions of the proposal of 2, and a proposal transmission time of 1676970957. The leader node receives the node state information transmitted the i^{th} follower node at the moment t1. The node state information includes the following: a height of 13 and a proposal hash value of null. In this case, in the consensus state information of the i^{th} follower node maintained by the leader node, the leader node updates the height value to 13, updates the proposal hash value to null, updates the quantity of transmissions to 0, and updates the transmission time to 0.

In other words, in this embodiment of the present disclosure, if the height value of the i^{th} follower node changes, the i^{th} follower node is used as a new follower node, and the quantity of transmissions and the transmission time in the consensus state information of the i^{th} follower node are updated to 0. When the proposal is to be retransmitted to the i^{th} follower node at a new height next time, a time interval is calculated from 0, thereby ensuring accuracy of the time interval.

In the foregoing embodiments, the leader node determines the quantity of transmissions of the first node, and determines the time interval before a next transmission of the proposal from the leader node to the first node based on the quantity of transmissions of the first node, the time interval being positively correlated with the quantity of transmissions, and then retransmits the proposal to the first node based on the time interval. During the proposal retransmission, the time interval before a next transmission of the proposal is gradually increased, which reduces continuous proposal transmission situations, so that network congestion between both nodes can be alleviated, thereby ensuring that the proposal can be transmitted to the nodes not receiving the proposal as quickly as possible, and occupation of a large part of a network bandwidth is avoided, thereby reducing impact on transmission of the proposal from the leader node to other nodes in a normal network. Therefore, during the proposal retransmission, gradually increasing the time interval before a next transmission of the proposal can improve Byzantine consensus processing in network conditions in which nodes are in a poor network and the nodes are disconnected from the chain and go offline, thereby improving the overall performance of the blockchain system.

In this embodiment of the present disclosure, a special condition that a follower node does not receive the proposal as a result of the salve node going offline instead of a network fault needs to be considered. Therefore, the leader node receives no consensus state of the node all the time. In this case, although the leader node retransmits the proposal to the follower node, the state of the follower node is not updated, and therefore the leader node continuously retransmits the proposal to the follower node. As quantity of transmissions increases, the time interval for retransmission calculated based on the foregoing time interval calculation method (e.g., the Fibonacci sequence) is excessively large. Even if the follower node goes online again, the slave cannot receive the retransmitted proposal in time, which affects timely receiving of the proposal, and affecting performance.

Based on the above, in this embodiment of the present disclosure, when the leader node does not receive node state information of a follower node within a preset time (e.g., one minute), it indicates that the follower node goes offline or is faulty, and the proposal is no longer retransmitted to the follower node.

In some embodiments, the leader node determines whether node state information of a node is not updated for a long time based on a state updating time. For example, the consensus state information of the follower node maintained in the leader node further includes a state updating time of the follower node. The state updating time of the follower node is a time of a last receipt of the state information of the follower node by the leader node.

The i^{th} follower node as an example. The consensus state information of the i^{th} follower node includes the following: an identifier of the i^{th} follower node, a height value, a proposal hash value at the height value, a quantity of transmissions of the proposal from the leader node to the i^{th} follower node (i.e., a proposal transmission quantity), a transmission time of a last transmission of the proposal from the leader node to the i^{th} follower node (i.e., a proposal transmission time), and a state updating time.

For example, the node state information of the i^{th} follower node is shown in Table 8:

TABLE 8
Consensus state information

Node identifier
Height value
Proposal hash value at a height value
Proposal transmission quantity
State updating time
Proposal transmission time
. . .

In some embodiments, if the consensus state information of the follower node maintained in the leader node includes the state updating time, before obtaining the quantity of transmissions corresponding to the first node from the consensus state information of the first node, the leader node first obtains the state updating time corresponding to the first node from the consensus state information of the first node; determines a second time difference between the state updating time corresponding to the first node and the current time; and obtains the quantity of transmissions corresponding to the first node from the consensus state information of the first node, and determines the time interval before a next transmission of the proposal from the leader node to the first node based on the quantity of transmissions corresponding to the first node, if the second time difference is less than or equal to a preset value.

In some embodiments, if the foregoing second time difference is greater than the preset value, the first node is determined as a faulty node, and retransmitting the proposal to the first node is stopped.

In other words, when the first node is a faulty node, the leader node stops retransmitting the proposal to the first node. Because no proposal is retransmitted, the quantity of retransmissions does not increase. Therefore, the time interval before a next transmission is not excessively large. When the first node goes online again and recovers consensus processing, the time interval before a next transmission of the proposal from the leader node to the first node is not very large, which ensures that the offline first node is recovered and can receive the retransmitted proposal as soon as possible.

In some embodiments, to further help the faulty first node receive the proposal in time after the first node goes online again, the leader node sets the quantity of transmissions and the transmission time in the consensus state information of the first node to 0 when determining that the first node is a faulty node. In this way, when the first node goes online again, the leader node can immediately transmit the proposal to the first node, further improving consensus performance of the blockchain system.

In the data transmission method in this embodiment of the present disclosure, the leader node in the blockchain system transmits the generated proposal to the N follower nodes in the regional chain system, and records the quantity of transmissions of the proposal from the leader node to each of the N follower nodes; next, the leader node receives the node state information transmitted by the M follower nodes of the N follower nodes, and determines the first node of the N follower nodes not receiving the proposal based on the node state information of each of the M follower nodes, M being a positive integer less than or equal to N; then, the leader node obtains the currently recorded quantity of transmissions of the proposal from the leader node to the first node, and determines the time interval before a next transmission of the proposal from the leader node to the first node based on the quantity of transmissions corresponding to the first node, the time interval being positively correlated with the quantity of transmissions; and finally, the leader node retransmits the proposal to the first node based on the time interval. In this embodiment of the present disclosure, when retransmitting the proposal to the first node, the leader node determines the time interval before a next transmission of the proposal from the leader node to the first node based on the currently recorded quantity of transmissions of the proposal from the leader node to the first node, the time interval being positively correlated with the quantity of transmissions. During the proposal retransmission, the time interval before a next transmission of the proposal is gradually increased, which reduces continuous proposal transmission situations, so that network congestion between both nodes can be alleviated, thereby ensuring that the proposal can be transmitted to the nodes not receiving the proposal as quickly as possible, and occupation of a large part of a network bandwidth is avoided, thereby reducing impact on transmission of the proposal from the leader node to other nodes in a normal network. Therefore, during the proposal retransmission, gradually increasing the time interval before a next transmission of the proposal can improve Byzantine consensus processing in network conditions in which nodes are in a poor network and the nodes are disconnected from the chain and go offline, thereby improving the overall performance of the blockchain system.

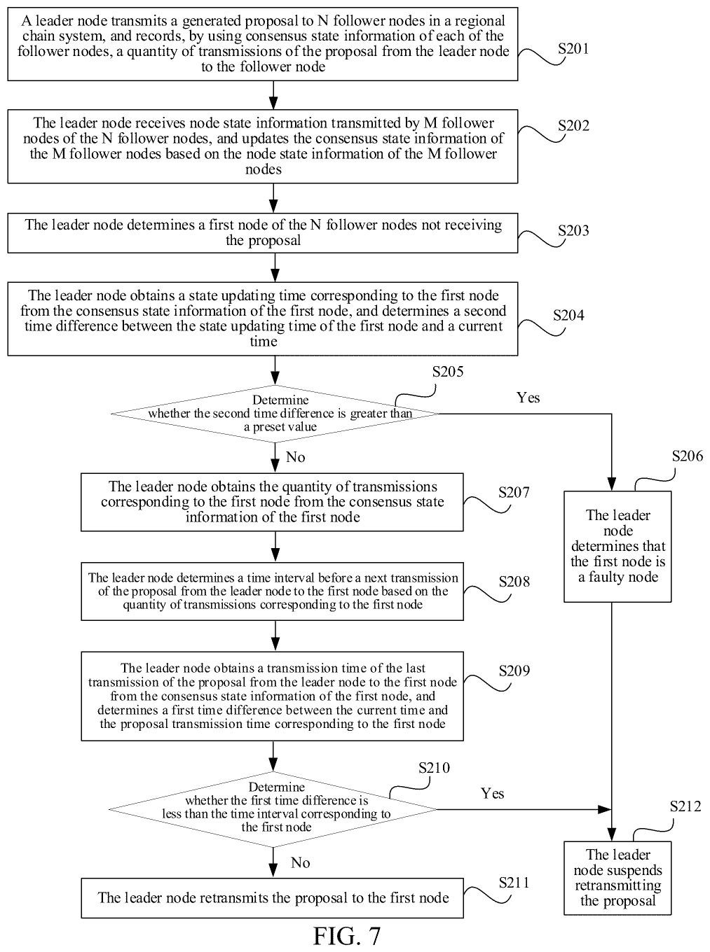

The above provides an overall description of the data transmission method provided in the embodiments of the present disclosure. An entire process of the data transmission method provided in the embodiments of the present disclosure is described below with reference to FIG. 7.

FIG. 7 is a schematic flowchart of a data transmission method according to an embodiment of the present disclosure. As shown in FIG. 7, the method includes the following operations:

S201: A leader node transmits a generated proposal to N follower nodes in a regional chain system, and records, by using consensus state information of each of the follower nodes, a quantity of transmissions of the proposal from the leader node to the follower node.

N is a positive integer.

In this embodiment of the present disclosure, the leader node maintains the consensus state information of each of the N follower nodes.

For example, the consensus state information of the follower node includes the quantity of transmissions of the proposal from the leader node to the follower node. In this way, the leader node records, by using the consensus state information, the quantity of transmissions of the proposal from the leader node to the follower node.

S202: The leader node receives node state information transmitted by M follower nodes of the N follower nodes, and updates the consensus state information of the M follower nodes based on the node state information of the M follower nodes.

M is a positive integer less than or equal to N.

Specific content included in the node state information and the consensus state information is not limited in this embodiment of the present disclosure.

In an example, the node state information of the follower node includes at least one of the following: an identifier of the follower node, a height value, and a proposal hash value at the height value.

In an example, the consensus state information of the follower node includes at least one of the following: an identifier of the node, a height value, a proposal hash value at the height value, a proposal transmission quantity (i.e., a quantity of transmissions of the proposal from the leader node to the follower node), a state updating time (i.e., a time of a last receipt of the node state information of the follower node by the leader node), and a proposal transmission time (i.e., a time of a last transmission of the proposal from the leader node to the follower node).

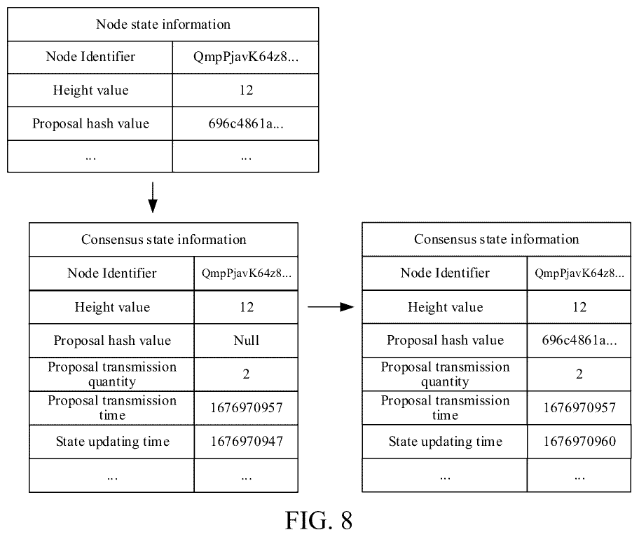

In this way, after receiving the node state information transmitted by the follower node, the leader node updates the consensus state information of the follower node maintained in the leader node based on the node state information of the follower node. For example, as shown in FIG. 8, the height value and the proposal hash value in the consensus state information are updated by using the height value and the proposal hash value in the node state information. In addition, the state updating time in the consensus state information is updated.

In some embodiments, when the height value in the node state information of the follower node received by the leader node is inconsistent with the height value in the consensus state information stored in the leader node, the proposal transmission quantity and the proposal transmission time in the consensus state information of the follower node are set to 0. In this way, the leader node can transmit the proposal to the follower node at a new height in time.

S203: The leader node determines a first node of the N follower nodes not receiving the proposal.

A specific manner in which the leader node determines the first node of the N follower nodes not receiving the proposal is not limited in this embodiment of the present disclosure.

In some embodiments, the leader node determines, based on a proposal hash value corresponding to a follower node, whether the follower node is the first node. For example, when the proposal hash value corresponding to the follower node is null, the follower node is determined as the first node. When the proposal hash value corresponding to the follower node is not null, it is determined that the follower node has received the proposal, and the proposal is not retransmitted to the follower node.

In this embodiment of the present disclosure, manners in which the leader node obtains the proposal hash value corresponding to the follower node include at least the following. In a first manner, the leader node directly obtains the proposal hash value corresponding to the follower node from the received node state information of the follower node. In a second manner, the leader node updates the proposal hash value in the consensus state information of the follower node by using a current proposal hash value in the node state information of the follower node, to obtain the proposal hash value corresponding to the follower node from the updated consensus state information.

In some embodiments, when M is less than N, the leader node determines nodes of the N follower nodes other than the M follower nodes as the first node.

S204: The leader node obtains a state updating time corresponding to the first node from the consensus state information of the first node, and determines a second time difference between the state updating time of the first node and a current time.

In this embodiment of the present disclosure, after determining the first node based on the foregoing operations, the leader node further needs to determine whether the first node is a faulty node. Specifically, the leader node obtains the state updating time corresponding to the first node from the consensus state information of the first node, and determines the second time difference between the state updating time corresponding to the first node and the current time.

Next, the leader node determines whether the first node is a faulty node based on the second time difference. Specifically, the following operations S205 and S206 are performed.

S205: Determine whether the second time difference is greater than a preset value.

If the second time difference is greater than the preset value, it indicates that the leader node does not receive the node state information transmitted by the first node for a long time, and therefore it is determined that the first node goes offline, in other words, it is determined that the first node is a faulty node. In this case, operation S206 of stop retransmitting the proposal to the first node is performed.

If the second time difference is less than or equal to the preset value, it indicates that the leader node received the node state information transmitted by the first node, and therefore it is determined that the first node does not go offline, in other words, it is determined that the first node is not a faulty node. In this case, operation S207 of retransmitting the proposal to the first node is performed.

S206: The leader node determines that the first node is a faulty node if the second time difference is greater than the preset value, and performs operation S212 of stopping retransmitting the proposal to the first node.

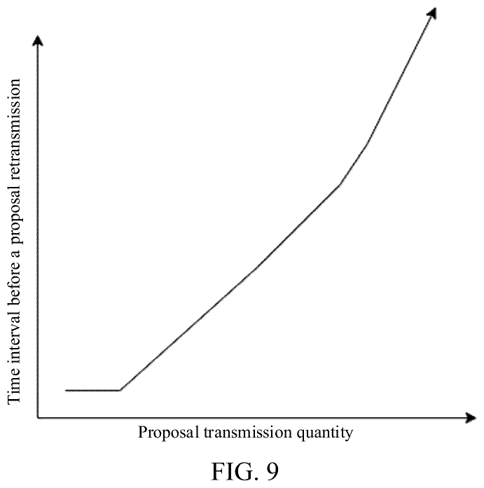

In this embodiment of the present disclosure, it may be learned from the foregoing description that the time interval before a next transmission of the proposal is no longer a fixed value, but a value that gradually increases. For example, the time interval before a retransmission of the proposal is a value calculated based on the Fibonacci sequence. As shown in FIG. 9, values from the first second to an X^{th} second gradually increase.

If the first node has been offline for a period of time, the first node is determined as a faulty node, and retransmission of the proposal to the first node is stopped. In this case, the quantity of transmissions of the proposal no longer increases. Therefore, when the first node goes online subsequently, because the proposal transmission quantity no longer increases, a calculated time interval before a next transmission of the proposal is not excessively large. In this way, after the node is recovered and updates the state thereof, the leader node can retransmit the proposal to the node quickly.

In some embodiments, in order to retransmit the proposal to the first node more quickly, if the first node is determined as a faulty node, the quantity of transmissions and the transmission time in the consensus state information of the first node are set to 0. In this way, the leader node can retransmit the proposal to the first node immediately after the first node goes online.

S207: The leader node obtains the quantity of transmissions corresponding to the first node from the consensus state information of the first node if the second time difference is less than or equal to the preset value.

S208: The leader node determines a time interval before a next transmission of the proposal from the leader node to the first node based on the quantity of transmissions corresponding to the first node.

The time interval is positively correlated with the quantity of transmissions.

In the data transmission method in this embodiment of the present disclosure, frequent transmission of the proposal to a faulty node can be prevented during Byzantine consensus processing within a blockchain. A transmission frequency of the proposal is dynamically adjusted based on a node state of the faulty node, so that a time interval before a next transmission of the proposal gradually increases. In this way, a burden on a network bandwidth can be significantly reduced, thereby enhancing performance of the Byzantine consensus processing.

A specific manner in which the leader node determines the time interval before a next transmission of the proposal from the leader node to the first node based on the quantity of transmissions corresponding to the first node is not limited in this embodiment of the present disclosure. For details, refer to the foregoing description of S103.

For example, the leader node determines the time interval before a next transmission of the proposal from the leader node to the first node based on the quantity of transmissions corresponding to the first node and a time interval between transmissions, among the quantity of transmissions corresponding to the first node, of the proposal from the leader node to the first node.

If the quantity of transmissions corresponding to the first node is greater than or equal to 2, the leader node determines the time interval before a next transmission of the proposal from the leader node to the first node based on a first time interval before the last transmission of the proposal from the leader node to the first node and a second time interval before a transmission before the last transmission of the proposal from the leader node to the first node. For example, the leader node determines a sum of the first time interval and the second time interval as the time interval before a next transmission of the proposal from the leader node to the first node.

If the quantity of transmissions corresponding to the first node is equal to 1, the leader node determines the first time interval before the last transmission of the proposal from the leader node to the first node as the time interval before a next transmission of the proposal from the leader node to the first node.

S209: The leader node obtains a transmission time of the last transmission of the proposal from the leader node to the first node from the consensus state information of the first node, and determines a first time difference between the current time and the proposal transmission time corresponding to the first node.

After determining the time interval before a next transmission of the proposal from the leader node to the first node based on the foregoing operation, the leader node retransmits the proposal to the first node based on the time interval. specifically, the leader node obtains the time of the last transmission of the proposal from the leader node to the first node from the consensus state information of the first node, and determines the first time difference between the current time and the proposal transmission time corresponding to the first node.

S210: Determine whether the first time difference is less than the time interval corresponding to the first node.

If the foregoing determined first time difference is greater than or equal to the time interval corresponding to the first node, it indicates that the proposal retransmission time of the first node arrives, and the following operation S211 is performed.

If the foregoing first time difference is less than the time interval corresponding to the first node, it indicates that the proposal retransmission time of the first node does not arrive, and the master node performs operation S212 and still waits. When the proposal retransmission time of the first node arrives, operation S211 is performed.

S211: The leader node retransmits the proposal to the first node.

S212: The leader node suspends retransmitting the proposal.

In the data transmission method provided in this embodiment of the present disclosure, the leader node maintains the consensus state information of each of the N follower nodes, and records the quantity of transmissions of the proposal from the leader node to each of the N follower nodes by using the consensus state information. In this way, the leader node receives the node state information transmitted by the M follower nodes of the N follower nodes, updates the consensus state information based on the node state information, and determines that the first node of the N follower nodes does not receive the proposal. Then, the leader node obtains the currently recorded quantity of transmissions of the proposal from the leader node to the first node from the consensus state information, and determines the time interval before a next transmission of the proposal from the leader node to the first node based on the quantity of transmissions corresponding to the first node, the time interval being positively correlated with the quantity of transmissions; and Finally, the leader node retransmits the proposal to the first node based on the time interval. In this embodiment of the present disclosure, the leader node records related information of each follower node by using the consensus state information, thereby knowing state information of each follower node effectively in time. Then the time interval before a next transmission of the proposal from the leader node to the first node is determined based on the known quantity of transmissions of the proposal from the leader node to the first node, the time interval being positively correlated with the quantity of transmissions. Therefore, during the proposal retransmission, gradually increasing the time interval before a next transmission of the proposal can not only ensure that the proposal can be transmitted to nodes not receiving the proposal as soon as possible, but also improve Byzantine consensus processing in network conditions in which nodes are in a poor network and the nodes are disconnected from the chain and go offline, thereby improving the overall performance of the blockchain system.

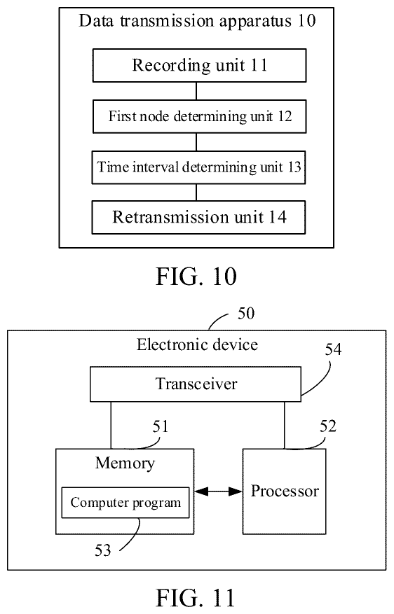

The method embodiment of the present disclosure is described in detail above with reference to FIG. 4 to FIG. 9. Apparatus embodiments of the present disclosure are described in detail below with reference to FIG. 10 to FIG. 11.

FIG. 10 is a schematic block diagram of a data transmission apparatus according to an embodiment of the present disclosure.

As shown in FIG. 9, a data transmission apparatus 10 includes:
a recording unit 11, configured to transmit a generated proposal to N follower nodes in a regional chain system, and record a quantity of transmissions of the proposal from the leader node to each of the N follower nodes, N being a positive integer;
a first node determining unit 12, configured to receive node state information transmitted by M follower nodes of the N follower nodes, and determine a first node of the N follower nodes not receiving the proposal based on the node state information of each of the M follower nodes, M being a positive integer less than or equal to N;
a time interval determining unit 13, configured to obtain a currently recorded quantity of transmissions of the proposal from the leader node to the first node, and determine a time interval before a next transmission of the proposal from the leader node to the first node based on the quantity of transmissions of the proposal from the leader node to the first node, the time interval being positively correlated with the quantity of transmissions of the proposal from the leader node to the first node, and the time interval being a time difference between a time of a next transmission of the proposal from the leader node to the follower node and a time of a last transmission of the proposal from the leader node to the follower node; and
a retransmission unit 14, configured to retransmit the proposal to the first node based on the time interval.

In some embodiments, the time interval determining unit 13 is specifically configured to determine the time interval before a next transmission of the proposal from the leader node to the first node based on the quantity of transmissions of the proposal from the leader node to the first node and a time interval between transmissions, among the quantity of transmissions of the proposal from the leader node to the first node, of the proposal from the leader node to the first node.

In some embodiments, the time interval determining unit 13 is specifically configured to: determine the time interval before a next transmission of the proposal from the leader node to the first node based on a first time interval before the last transmission of the proposal from the leader node to the first node and a second time interval before a transmission before the last transmission of the proposal from the leader node to the first node if the quantity of transmissions of the proposal from the leader node to the first node is greater than or equal to 2; or determine the first time interval before the last transmission of the proposal from the leader node to the first node as the time interval before a next transmission of the proposal from the leader node to the first node if the quantity of transmissions of the proposal from the leader node to the first node is equal to 1.

In some embodiments, the time interval determining unit 13 is specifically configured to determine a sum of the first time interval and the second time interval as the time interval before a next transmission of the proposal from the leader node to the first node.

In some embodiments, the leader node has consensus state information of each of the N follower nodes stored therein, for each of the N follower nodes, the consensus state information of the follower node including the quantity of transmissions of the proposal from the leader node to the follower node. The recording unit 11 is specifically configured to record, for each of the N follower nodes through the consensus state information of the follower node, the quantity of transmissions of the proposal from the leader node to the follower node. The first node determining unit 12 is specifically configured to obtain the quantity of transmissions of the proposal from the leader node to the first node from the consensus state information of the first node.

In some embodiments, for each of the N follower nodes, the node state information of the follower node includes a current proposal hash value of the follower node, and the consensus state information of the follower node further includes a proposal hash value. Before determining the first node of the N follower nodes not receiving the proposal based on the node state information of each of the M follower nodes, the first node determining unit 12 is further configured to: update, for each of the M follower nodes, the proposal hash value in the consensus state information of the follower node based on the current proposal hash value in the node state information of the follower node; and determine, for each of the N follower nodes, the follower node as the first node if the updated proposal hash value in the consensus state information of the follower node is null.

In some embodiments, the first node determining unit 12 is further configured to determine nodes of the N follower nodes other than the M follower nodes as the first node if M is less than N.

In some embodiments, for each of the N follower nodes, the consensus state information of the follower node further includes the transmission time of the last transmission of the proposal from the leader node to the follower node. The retransmission unit 14 is specifically configured to: obtain the transmission time of the last transmission of the proposal from the leader node to the first node from the consensus state information of the first node; determine a first time difference between a current time and the proposal transmission time corresponding to the first node; and retransmit the proposal to the first node if the first time difference is greater than or equal to the time interval.

In some embodiments, after retransmitting the proposal to the first node, the retransmission unit 14 is further configured to increase the quantity of transmissions of the proposal in the consensus state information of the first node by 1, and update the proposal transmission time in the consensus state information of the first node to the current time.

In some embodiments, for each of the N follower nodes, the node state information of the follower node includes a height value of the follower node in the blockchain system at a current moment, and the consensus state information of the follower node further includes a height value of the follower node. The retransmission unit 14 is further configured to update, for an i^{th} follower node of the M follower nodes, the height value in the consensus state information of the i^{th} follower node to the height value in the node state information of the i^{th} follower node and reset the quantity of transmissions and the transmission time in the consensus state information of the i^{th} follower node to 0, if the height value in the node state information of the i^{th} follower node is inconsistent with the height value in the consensus state information of the i^{th} follower node.

In some embodiments, for each of the N follower nodes, the consensus state information of the follower node further includes a state updating time of the follower node, the state updating time of the follower node being a time of a last receipt pf the state information of the follower node by the leader node. Before obtaining the quantity of transmissions of the proposal from the leader node to the first node from the consensus state information of the first node, the first node determining unit 12 is further configured to: obtain the state updating time of the first node from the consensus state information of the first node; determine a second time difference between the state updating time corresponding to the first node and the current time; and obtain the quantity of transmissions of the proposal from the leader node to the first node from the consensus state information of the first node if the second time difference is less than or equal to a preset value.

In some embodiments, the first node determining unit 12 is further configured to determine the first node as a faulty node and stop retransmitting the proposal to the first node, if the second time difference is greater than the preset value.

In some embodiments, the first node determining unit 12 is further configured to set the quantity of transmissions and the transmission time in the consensus state information of the first node to 0, if the first node is a faulty node.

The apparatus embodiment and the method embodiment may correspond to each other. For similar descriptions, refer to the method embodiment. To avoid repetition, details are not described herein. Specifically, the apparatus shown in FIG. 10 may perform the foregoing method embodiment. In addition, the foregoing and other operations and/or functions of the modules in the apparatus are respectively configured for implementing the foregoing method embodiment. For brevity, details are not described herein.

The apparatus in an embodiment of the present disclosure is described above from the perspective of functional units or modules with reference to the drawings. The functional units or modules may be implemented in a form of hardware, or may be implemented by using an instruction in a form of software, or may be implemented by using a combination of hardware and software modules. Specifically, the operations of the method embodiment of the embodiments of the present disclosure may be completed by using an integrated logic circuit of hardware in a processor and/or instructions in a form of software. The operations of the method disclosed with reference to the embodiments of the present disclosure may be directly performed by a hardware decoding processor, or may be performed and completed by a combination of hardware and software modules in the decoding processor. In some embodiments, the software modules may be located in a storage medium, such as a RAM, a flash memory, a random access memory (RAM), a programmable read-only memory (PROM), an electrically erasable programmable memory (EEPROM), and a register. The storage medium is located in the memory, and a processor reads information in the memory and completes the operations in the foregoing method embodiment in combination with hardware thereof.

FIG. 11 is a schematic block diagram of an electronic device according to an embodiment of the present disclosure. The electronic device may be the foregoing terminal device or server, and the electronic device is configured to perform the foregoing method embodiment.

As shown in FIG. 11, the electronic device 50 may include:
a memory 51 and a processor 52. The memory 51 is configured to store a computer program 53 and transmit the computer program 53 to the processor 52. In other words, the processor 52 may invoke the computer program 53 from the memory 51 and run the computer program to implement the method in the embodiments of the present disclosure.

For example, the processor 52 may be configured to perform the operations in the foregoing method according to instructions in the computer program 53.

In some embodiments of the present disclosure, the processor 52 may include but is not limited to:
a general-purpose processor, a digital signal processor (DSP), an application specific integrated circuit (ASIC), a field programmable gate array (FPGA) or another programmable logic device, a discrete gate or a transistor logic device, and a discrete hardware component.

In some embodiments of the present disclosure, the memory 51 includes but is not limited to
a volatile memory and/or a non-volatile memory. The non-volatile memory may be a ROM, a PROM, an erasable programmable read-only memory (EPROM), an EEPROM, or a flash memory. The volatile memory may be a RAM which is used as an external cache. By way of example but not limitation, many forms of RAMs, such as a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM) may be used.

In some embodiments of the present disclosure, the computer program 53 may be split into one or more modules. The one or more modules are stored in the memory 51, and are executed by the processor 52 to complete the method provided in the present disclosure. The one or more modules may be a series of computer program instruction sections that can implement specific functions. The instruction sections are configured for describing an execution process of the computer program 53 in the electronic device.

As shown in FIG. 11, the electronic device 50 may further include:
a transceiver 54. The transceiver 54 may be connected to the processor 52 or the memory 51.

The processor 52 may control the transceiver 54 to communicate with another device. Specifically, the transceiver may transmit information or data to the another device, or may receive information or data transmitted by the another device. The transceiver 54 may include a transmitter and a receiver. The transceiver 54 may further include an antenna. One or more antennas may be arranged.

The components of the electronic device 50 are connected through a bus system. In addition to a data bus, the bus system further includes a power bus, a control bus, and a state signal bus.

According to an aspect of the present disclosure, a computer storage medium is provided. The computer storage medium has a computer program stored therein. The computer program, when executed by a computer, causes the computer to perform the method in the foregoing method embodiment.

An embodiment of the present disclosure further provides a computer program product including instructions. The instructions, when executed by a computer, cause the computer to perform the method in the foregoing method embodiment.

According to another aspect of the present disclosure, a computer program product or a computer program is provided. The computer program product or the computer program includes computer instructions. The computer instructions are stored in a computer-readable storage medium. A processor of an electronic device reads the computer instructions from the computer-readable storage medium. The processor executes the computer instruction, to cause the electronic device to perform the method in the foregoing method embodiment.

In other words, when the embodiments are implemented by using software, all or some of the embodiments may be implemented in a form of a computer program product. The computer program product includes one or more computer instructions. When the computer instruction is loaded and executed on the computer, all or some processes or functions according to the embodiments of the present disclosure are generated. The computer may be a general-purpose computer, a dedicated computer, a computer network, or other programmable apparatuses. The computer instruction may be stored in the computer-readable storage medium, or may be transmitted from a computer-readable storage medium to another computer-readable storage medium. For example, the computer instruction may be transmitted from a website, a computer, a server, or a data center to another website, computer, server, or data center in a wired manner (for example, through a coaxial cable, an optical fiber, or a digital subscriber line (DSL)) or a wireless manner (for example, in an infrared, radio, or microwave manner). The computer-readable storage medium may be any usable medium that can be accessed by the computer, or may be a data storage device, such as a server or a data center in which one or more usable media are integrated. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

A person of ordinary skill in the art may be aware that, modules, algorithms, and operations in the examples described with reference to the embodiments disclosed in this specification may be implemented by electronic hardware or a combination of computer software and electronic hardware. Whether the functions are executed in a mode of hardware or software depends on particular applications and design constraint conditions of the technical solutions. A person skilled in the art may use different methods to implement the described functions for each particular application, but it is not considered that such implementation goes beyond the scope of the present disclosure.

In the plurality of embodiments provided in the present disclosure, the disclosed system, apparatus, and method may be implemented in another manner. For example, the described apparatus embodiment is merely an example. For example, division into the modules is merely logical function division, and may be other division during actual implementation. For example, a plurality of modules or components may be combined or integrated into another system, or some features may be ignored or not executed. In addition, the displayed or discussed mutual coupling or direct coupling or communication connection may be implemented through some interfaces. The indirect coupling or communication connection between the apparatuses or modules may be implemented in an electronic, mechanical, or another form.

The modules described as separate components may or may not be physically separated, and the components displayed as modules may or may not be physical modules. They may be located in one place, or may be distributed over a plurality of network units. Some or all of the modules may be selected according to actual needs to achieve the objectives of the solutions of the embodiments. For example, the functional modules in the embodiments of the present disclosure may be integrated into one processing module, each of the modules may exist alone physically, or two or more modules may be integrated into one module.

The foregoing descriptions are merely specific implementations of the present disclosure, and are not intended to limit the protection scope of the present disclosure. Any variation or replacement readily figured out by a person skilled in the art within the technical scope disclosed in the present disclosure falls within the protection scope of the present disclosure. Therefore, the protection scope of the present disclosure shall be subject to the protection scope of the claims.

What is claimed is:

1. A data transmission method, the method being applied to a leader node in a blockchain system, and comprising:
transmitting a generated proposal to N follower nodes in a regional chain system, and recording a quantity of transmissions of the proposal from the leader node to each of the N follower nodes, N being a positive integer;
receiving node state information transmitted by M follower nodes of the N follower nodes, and determining a first node of the N follower nodes not receiving the proposal based on the node state information of each of the M follower nodes, M being a positive integer less than or equal to N;
obtaining a currently recorded quantity of transmissions of the proposal from the leader node to the first node, and determining a time interval before a next transmission of the proposal from the leader node to the first node based on the quantity of transmissions of the proposal from the leader node to the first node, the time interval being positively correlated with the quantity of transmissions of the proposal from the leader node to the first node, and the time interval being a time difference between a time of a next transmission of the proposal from the leader node to the follower node and a time of a last transmission of the proposal from the leader node to the follower node; and
retransmitting the proposal to the first node based on the time interval.

2. The method according to claim 1, wherein the determining a time interval before a next transmission of the proposal from the leader node to the first node based on the quantity of transmissions of the proposal from the leader node to the first node comprises:
determining the time interval before a next transmission of the proposal from the leader node to the first node based on the quantity of transmissions of the proposal from the leader node to the first node and a time interval between transmissions, among the quantity of transmissions of the proposal from the leader node to the first node, of the proposal from the leader node to the first node.

3. The method according to claim 2, wherein the determining the time interval before a next transmission of the proposal from the leader node to the first node based on the quantity of transmissions of the proposal from the leader node to the first node and a time interval between transmissions, among the quantity of transmissions of the proposal from the leader node to the first node, of the proposal from the leader node to the first node comprises:
in response to the quantity of transmissions of the proposal from the leader node to the first node being greater than or equal to 2, determining the time interval before a next transmission of the proposal from the leader node to the first node based on a first time interval before the last transmission of the proposal from the leader node to the first node and a second time interval before a transmission before the last transmission of the proposal from the leader node to the first node; and
in response to the quantity of transmissions of the proposal from the leader node to the first node being 1, determining the first time interval before the last transmission of the proposal from the leader node to the first node as the time interval before a next transmission of the proposal from the leader node to the first node.

4. The method according to claim 3, wherein the determining the time interval before a next transmission of the proposal from the leader node to the first node based on a first time interval before the last transmission of the proposal from the leader node to the first node and a second time interval before a transmission before the last transmission of the proposal from the leader node to the first node comprises:
determining a sum of the first time interval and the second time interval as the time interval before a next transmission of the proposal from the leader node to the first node.

5. The method according to claim 1, wherein the leader node has consensus state information of each of the N follower nodes stored therein, for each of the N follower nodes, the consensus state information of the follower node comprising the quantity of transmissions of the proposal from the leader node to the follower node, and the recording a quantity of transmissions of the proposal from the leader node to each of the N follower nodes comprises:
recording, for each of the N follower nodes through the consensus state information of the follower node, the quantity of transmissions of the proposal from the leader node to the follower node; and
the obtaining a currently recorded quantity of transmissions of the proposal from the leader node to the first node comprises:
obtaining the quantity of transmissions of the proposal from the leader node to the first node from the consensus state information of the first node.

6. The method according to claim 5, wherein for each of the N follower nodes, the node state information of the follower node comprises a current proposal hash value of the follower node, and the consensus state information of the follower node further comprises a proposal hash value, and before the determining a first node of the N follower nodes not receiving the proposal based on the node state information of each of the M follower nodes, the method further comprises:
updating, for each of the M follower nodes, the proposal hash value in the consensus state information of the follower node based on the current proposal hash value in the node state information of the follower node; and
the determining a first node of the N follower nodes not receiving the proposal based on the node state information of each of the M follower nodes comprises:
determining, for each of the N follower nodes, the follower node as the first node in response to the updated proposal hash value in the consensus state information of the follower node is null.

7. The method according to claim 6, further comprising:
determining nodes of the N follower nodes other than the M follower nodes as the first node in response to M is less than N.

8. The method according to claim 5, wherein for each of the N follower nodes, the consensus state information of the follower node further comprises the transmission time of the last transmission of the proposal from the leader node to the follower node, and the retransmitting the proposal to the first node based on the time interval comprises:
obtaining the transmission time of the last transmission of the proposal from the leader node to the first node from the consensus state information of the first node;
determining a first time difference between a current time and the proposal transmission time corresponding to the first node; and
retransmitting the proposal to the first node in response to the first time difference is greater than or equal to the time interval.

9. The method according to claim 8, wherein after the retransmitting the proposal to the first node, the method further comprises:
increasing the quantity of transmissions of the proposal in the consensus state information of the first node by 1, and updating the proposal transmission time in the consensus state information of the first node to the current time.

10. The method according to claim 8, wherein for each of the N follower nodes, the node state information of the follower node comprises a height value of the follower node in the blockchain system at a current moment, the consensus state information of the follower node further comprises a height value of the follower node, and the method further comprises:
updating, for an i^{th} follower node of the M follower nodes, the height value in the consensus state information of the i^{th} follower node to the height value in the node state information of the i^{th} follower node and resetting the quantity of transmissions and the transmission time in the consensus state information of the i^{th} follower node to 0, in response to the height value in the node state information of the i^{th} follower node is inconsistent with the height value in the consensus state information of the i^{th} follower node.

11. The method according to claim 8, wherein for each of the N follower nodes, the consensus state information of the follower node further comprises a state updating time of the follower node, the state updating time of the follower node being a time of a last receipt of the state information of the follower node by the leader node, and before the obtaining the quantity of transmissions of the proposal from the leader node to the first node from the consensus state information of the first node, the method further comprises:
obtaining the state updating time of the first node from the consensus state information of the first node; and
determining a second time difference between the state updating time of the first node and the current time; and
the obtaining the quantity of transmissions of the proposal from the leader node to the first node from the consensus state information of the first node comprises:
obtaining the quantity of transmissions of the proposal from the leader node to the first node from the consensus state information of the first node in response to the second time difference is less than or equal to a preset value.

12. The method according to claim 11, further comprising:
determining the first node as a faulty node and stopping retransmitting the proposal to the first node, in response to the second time difference is greater than the preset value.

13. The method according to claim 12, further comprising:
setting the quantity of transmissions and the transmission time in the consensus state information of the first node to 0, in response to the first node is a faulty node.

14. A data transmission apparatus, the apparatus being applied to a leader node in a blockchain system, and comprising:
a processor and a memory,
the memory being configured to store a computer program; and
the processor being configured to execute the computer program to implement:
transmitting a generated proposal to N follower nodes in a regional chain system, and recording a quantity of transmissions of the proposal from the leader node to each of the N follower nodes, N being a positive integer;
receiving node state information transmitted by M follower nodes of the N follower nodes, and determining a first node of the N follower nodes not receiving the proposal based on the node state information of each of the M follower nodes, M being a positive integer less than or equal to N;
obtaining a currently recorded quantity of transmissions of the proposal from the leader node to the first node, and determining a time interval before a next transmission of the proposal from the leader node to the first node based on the quantity of transmissions of the proposal from the leader node to the first node, the time interval being positively correlated with the quantity of transmissions of the proposal from the leader node to the first node, and the time interval being a time difference between a time of a next transmission of the proposal from the leader node to the follower node and a time of a last transmission of the proposal from the leader node to the follower node; and
retransmitting the proposal to the first node based on the time interval.

15. The apparatus according to claim 14, wherein the determining a time interval before a next transmission of the proposal from the leader node to the first node based on the quantity of transmissions of the proposal from the leader node to the first node comprises:
determining the time interval before a next transmission of the proposal from the leader node to the first node based on the quantity of transmissions of the proposal from the leader node to the first node and a time interval between transmissions, among the quantity of transmissions of the proposal from the leader node to the first node, of the proposal from the leader node to the first node.

16. The apparatus according to claim 15, wherein the determining the time interval before a next transmission of the proposal from the leader node to the first node based on the quantity of transmissions of the proposal from the leader node to the first node and a time interval between transmissions, among the quantity of transmissions of the proposal from the leader node to the first node, of the proposal from the leader node to the first node comprises:
in response to the quantity of transmissions of the proposal from the leader node to the first node being greater than or equal to 2, determining the time interval before a next transmission of the proposal from the leader node to the first node based on a first time interval before the last transmission of the proposal from the leader node to the first node and a second time interval before a transmission before the last transmission of the proposal from the leader node to the first node; and
in response to the quantity of transmissions of the proposal from the leader node to the first node being 1, determining the first time interval before the last transmission of the proposal from the leader node to the first node as the time interval before a next transmission of the proposal from the leader node to the first node.

17. The apparatus according to claim 16, wherein the determining the time interval before a next transmission of the proposal from the leader node to the first node based on a first time interval before the last transmission of the proposal from the leader node to the first node and a second time interval before a transmission before the last transmission of the proposal from the leader node to the first node comprises:
determining a sum of the first time interval and the second time interval as the time interval before a next transmission of the proposal from the leader node to the first node.

18. The apparatus according to claim 14, wherein the leader node has consensus state information of each of the N follower nodes stored therein, for each of the N follower nodes, the consensus state information of the follower node comprising the quantity of transmissions of the proposal from the leader node to the follower node, and the recording a quantity of transmissions of the proposal from the leader node to each of the N follower nodes comprises:
recording, for each of the N follower nodes through the consensus state information of the follower node, the quantity of transmissions of the proposal from the leader node to the follower node; and
the obtaining a currently recorded quantity of transmissions of the proposal from the leader node to the first node comprises:
obtaining the quantity of transmissions of the proposal from the leader node to the first node from the consensus state information of the first node.

19. The apparatus according to claim 18, wherein for each of the N follower nodes, the node state information of the follower node comprises a current proposal hash value of the follower node, and the consensus state information of the follower node further comprises a proposal hash value, and before the determining a first node of the N follower nodes not receiving the proposal based on the node state information of each of the M follower nodes, the method further comprises:
updating, for each of the M follower nodes, the proposal hash value in the consensus state information of the follower node based on the current proposal hash value in the node state information of the follower node; and
the determining a first node of the N follower nodes not receiving the proposal based on the node state information of each of the M follower nodes comprises:
determining, for each of the N follower nodes, the follower node as the first node in response to the updated proposal hash value in the consensus state information of the follower node is null.

20. A non-transitory computer-readable storage medium, configured to store a computer program, the computer program causing a computer to perform:
transmitting a generated proposal to N follower nodes in a regional chain system, and recording a quantity of transmissions of the proposal from the leader node to each of the N follower nodes, N being a positive integer;
receiving node state information transmitted by M follower nodes of the N follower nodes, and determining a first node of the N follower nodes not receiving the proposal based on the node state information of each of the M follower nodes, M being a positive integer less than or equal to N;
obtaining a currently recorded quantity of transmissions of the proposal from the leader node to the first node, and determining a time interval before a next transmission of the proposal from the leader node to the first node based on the quantity of transmissions of the proposal from the leader node to the first node, the time interval being positively correlated with the quantity of transmissions of the proposal from the leader node to the first node, and the time interval being a time difference between a time of a next transmission of the proposal from the leader node to the follower node and a time of a last transmission of the proposal from the leader node to the follower node; and
retransmitting the proposal to the first node based on the time interval.
